(19) United States
(12) Patent Application Publication
(10) Pub. No.: US 2006/0236865 A1
(43) Pub. Date: Oct. 26, 2006

(54) Method and device for condensing of periodically and momentarily released quatities of vapour

(76) Inventors: Pieter Jellema, Oss (NL); Jelle Luutzen Nijdam, Oss (NL)

Correspondence Address: Varnum Riddering Schmidt & Howlett, Bridgewater Place, PO Box 352, Grand Rapids, MI, 49501-0352, US

(21) Appl. No.: 10/536,283

(22) PCT Filed: Nov. 25, 2003
(86) PCT No.: PCT/NL03/00832

§ 371 Date: Apr. 18, 2006

(30) Foreign Application Priority Data
Nov. 25, 2002 (NL) 1021988

(51) Int. Cl. B01D 47/00

(52) U.S. Cl. 95/149

(57) ABSTRACT

A method and device for condensing periodically and momentarily released large quantities of vapor, such as water vapor, with condensable and non-condensable gaseous components by condensing the condensable components of the vapor in an enclosed space (5) by means of a cooling fluid (12), such as water, after which the heated cooling fluid and condensed components are together discharged from the enclosed space (15) via a fluid discharge pipe and the non-condensable components are discharged from the enclosed space via a gas discharge pipe, characterized in that the vapor is led through and along a thermal buffer body (6) having a relatively large thermal buffering mass and heat-exchanging surface, which is vertically arranged in the enclosed space, so that the periodically and momentarily released large quantities of vapor supplied from the bottom up are condensed while the thermal buffer body periodically heats up simultaneously, which body is continuously cooled by coolant supplied (12) from above and flowing or dripping down.

The invention relates to a method for condensing periodically and momentarily released large quantities of vapor, such as water vapor, with condensable and non-condensable gaseous components, by condensing the condensable components of the vapor in an enclosed space by means of a cooling fluid, such as water, after which the thus heated cooling fluid and condensed components are together discharged from the enclosed space via a fluid discharge pipe and the non-condensable components via a gas discharge pipe.

An example of an industrial process in which large quantities of o vapor are periodically and virtually momentarily released is the so-called steam peeling for root crops, such as potatoes, beets and carrots. Steam peeling takes place in a pressure vessel also called peeling vessel, which is partly filled with the product to be peeled. The peeling vessel is closed and, for a certain time, the steaming time, the products are brought under steam pressure (for instance 16 bars). Then, the steam is blown off within a short time, while the pressure in the pressure vessel rapidly decreases. As a result of this rapid pressure drop in combination with a high temperature (>100° C.) of the product skin, explosive evaporation takes place of the heated water fraction directly under the product skin. This causes the skin to come loose, after which the products have been peeled. Then, the vessel is opened and the products are discharged. Characteristic of such steam peeling processes are the momentary vapor emissions during blowing off. The period during which the vapor emissions are released can be of the order of magnitude of 1 to 3 sec; the released quantity of vapor of the order magnitude of 10 to 30 kg. Moreover, in addition to a large heat content, these vapor emissions also contain odor components.

A known technique for reducing the quantity of steam blown off is condensation, which also minimizes the odor emission. For this purpose, it is known to make use of a so-called spray condenser, consisting of a hollow vessel having a sprinkling installation at the top side. Via a supply pipe, the released vapor emission is supplied to the spray condenser and is then sprinkled from the top side with relatively cold water. The vapor emission condenses on the relatively cold water drops. Non-condensable components are discharged to the atmosphere via a discharge pipe of the spray condenser.

A drawback of this known technique is that, during the moment when the emission is released, it is to be condensed simultaneously. In the short period available for this, consequently, a great thermal power is to be discharged. This thermal power to be momentarily discharged may be of the order of magnitude of 7.5 MW to 50 MW. In order to be able to absorb this instantaneously released quantity of heat by means of the sprinkling water, the sprinkling water flow rate needs to be relatively high and the sprinkling water needs to have a relatively low temperature. If these conditions are satisfied, however, the heating up of the sprinkling water is so slight that its temperature is too low for useful reuse. Another disadvantageous aspect is the high water consumption of the spray condenser. In general, as a result, not all steam is condensed and a part of the vapor emission is still discharged to the atmosphere.

It is an object of the invention to improve a method as described in more detail hereinabove, such that momentarily and periodically released large quantities of vapor can effectively and efficiently be processed using relatively small quantities of coolant and a possible odor emission is minimized.

According to the invention, this is achieved by a method of the type described in the opening paragraph, when the vapor is led through and along a thermal buffer body having a relatively large thermal buffering mass and heat exchanging surface, which is vertically arranged in the enclosed space, so that the periodically and momentarily released large quantities of vapor supplied from the bottom up are condensed, while, simultaneously, periodically heating up the thermal buffer body, which is continuously cooled down by coolant supplied from above and flowing or dripping down. These measures provide a continuously cooled condensation body having a thermal buffering capacity, so that momentarily and periodically released quantities of vapor contact a relatively cold mass and can thus be condensed rapidly and effectively, with the thermal energy thus released being substantially absorbed by the thermal buffer body, which then gradually and continuously transfers this thermal energy to the coolant, so that the thermal buffer body is again a relatively cold mass at the next vapor emission. By continuous cooling combined with periodic condensing, the quantity of coolant needed can remain relatively low. Also, the supply temperature does not need to be very low, so that the discharge temperature can have such a level and, in addition, as a result of the thermal buffering, can be of such a constant level that it enables the efficient utilization of residual heat from the discharged coolant.

By properly dimensioning and controlling all this, it can be achieved that, at the top side of the thermal buffer body, a temperature prevails which is always more or less equal to the temperature of the coolant supplied, while the temperature at the bottom side of the thermal buffer body is more or less continuously equal to that of the condensation temperature of the vapor. Thus, large quantities of vapor supplied at a high rate can rapidly be condensed, while the thus released thermal energy can be efficiently utilized and, by effective condensing, odor emission can be minimized. In addition, as a result of the rapid reduction of the vapor velocities, the noise emission accompanying the blowing off of the vapor is reduced.

For optimizing the process, it is preferably taken as a starting point that the thermal buffering mass of the thermal buffer body is adjusted so as to be able to absorb the condensation heat of a predetermined quantity of vapor within a short time. This is a clear difference with other heat exchange processes, which seek to achieve a cooling by a direct contact as intensive as possible between the coolant and the vapor, while, in the present process, condensation takes place by contacting the vapor with the relatively cold thermal buffer body, while the coolant, by continuous cooling, brings the thermal buffer body to the desired relatively low temperature in order to be able to rapidly and effectively condense a next flow surge. Here, depending on the quantity of steam to be condensed to be supplied, the mass of the thermal buffer body can be calculated as follows:
Mass of buffer=Mass of steam×(condensation heat/heat capacity of buffer material/heating up)
A possible numerical example of this is:
Mass of steam: 25 kg
Condensation heat: 2500 kJ/kg of steam
Steel: heat capacity: 0.46 kJ kg/° C.
Heating up of buffer by condensation of steam: 30° C.
It then follows from this that the mass of the buffer needs to be 4529 kg, that is, in these conditions, the mass of the buffer is 181× the mass of the quantity of steam to be condensed which is supplied.

For further optimization of the process, it is preferred that the heat exchanging surface of the thermal buffer body be adjusted so as to be able to absorb the condensation heat of a predetermined quantity of vapor within a short time, so that the large vapor flow can be momentarily condensed. The mass flow of steam (x kg/s) determines this, while the following can be used for calculation:
Mass flow of steam (peak)×condensation heat=heat transfer coefficient×surface×temperature difference of steam/buffer
or
Surface=mass flow of steam×condensation heat/(heat transfer coefficient×temperature difference)
A possible numerical example of this is:
Mass flow of steam (peak): 40 kg/s
Condensation heat: 2500 kJ/kg of steam
Heat transfer coefficient for condensation: approx. 1.5 kW/(kg. ° C.)
Temperature difference of steam/buffer: 40° C.
It then follows from this that the surface is 1670 m².

A thermal buffer body as intended can be formed by a bed consisting of randomly poured bodies which together form a porous structure having a large volumetric heat-exchanging surface. The bed is enclosed by a tubular container and supported by a transmissive grid floor. However, such a bed needs to have large dimensions and a large mass, which involves a relatively expensive construction. Further, such a bed is difficult to clean and susceptible to pollution, which, in use for, for instance, steam peeling processes, may result in obstruction of the bed. Also, an incomplete irrigation by coolant can lead to less uniform discharge of the stored heat when use is made of ceramic bodies as a result of the poor heat conductivity of such a material. Another possibility is to form the thermal buffer body from metal tubes. Although these have a better heat conductivity and are less susceptible to obstruction, a thermal buffer body formed from such tubes is still sizeable and expensive.

Therefore, according to the invention, further, it is preferred that the vapor flowing through and along the thermal buffer body be led through a plurality of channels substantially identical in shape which are arranged in the thermal buffer body in an orderly manner. As a result of these measures, across the thermal buffer body, a relatively small and equally distributed pressure drop will occur, while sufficient turbulence for a good heat transfer remains present, so that the thermal buffer body can have a relatively compact design.

If, according to a further preferred embodiment of the invention, it is provided that the rising vapor in the channels is subjected to at least one deflection in the flow direction, this effect can be increased still further, which results in the volume of the thermal buffer body needing to be, for instance, only a quarter of that of a bed from randomly poured bodies. This because, on the one hand, sufficient condensation surface is realized, while, on the other hand, sufficient flow surface remains available for the vapor, so the flow losses remain within the limits acceptable for this. Also, by this manner of working, it is achieved that the thermal buffer body is homogeneously irrigated as a result of the orderly structure.

Between two vapor emissions, the thermal buffer body is cooled from the top to the bottom by means of irrigating with coolant. For working under atmospheric conditions, this means that, upon cooling down, air is sucked into the tubular container, which air is emitted again upon the subsequent heating up of the thermal buffer body. This increases a possible odor emission. In order to reduce this effect, according to a further embodiment of the invention, it is proposed that the non-condensable components be discharged via the gas discharge pipe only when an overpressure prevails in the enclosed space in relation to the space to which the non-condensable components are discharged. Thus, during cooling down, the connection with the atmosphere can be broken so that, during cooling down, no air can be sucked in from outside.

This means that, during the cooling down, an underpressure is created in the thermal buffer body. As a result, a suction force is applied, by which a more rapid pressure decrease in the vapor source, for instance a peeling vessel, can be achieved. The peeling vessel can thus be opened sooner, which allows shorter cycle times. Also, the reduction of the blow-off time means that the heating through of the product to be peeled is reduced, which, in turn, reduces the peeling losses.

All these advantages can be further increased if, according to a further embodiment of the invention, in the enclosed space, an underpressure is generated. Then, in the thermal buffer body, substantially only water vapor will be present. This means that temperature and pressure are coupled directly according to a physical principle, as a result of which the temperature in the whole condenser will be uniform and is only determined by the pressure prevailing in the container.

The invention further relates to a device for condensing periodically and momentarily released large quantities of vapor, such as water vapor, with condensable and non-condensable gaseous components, which device is provided with a housing which forms an enclosed space and is provided with a steam supply, a fluid discharge, a gas discharge and a coolant supply. In order to make such a device suitable for rapidly, effectively and efficiently being able to periodically and momentarily condense large quantities of vapor supplied, it is proposed according to the invention that, in the enclosed space, a compacted thermal buffer body extending in the vertical direction and provided with a plurality of passages be arranged, which has a relatively large thermal buffering mass and heat-exchanging surface, with the steam supply and the fluid discharge being located vertically below the thermal buffer body and the gas discharge and coolant supply being located vertically above the thermal buffer body. Due to a compacted design, while preserving a relatively small overall size, as elucidated hereinabove, the thermal buffer body can be provided with sufficient mass and surface to rapidly absorb the momentarily supplied thermal energy, after which this energy is gradually, uniformly and continuously passed to the coolant, so that supply and discharge temperature thereof can be optimally adjusted to reutilizing the thermal energy abstracted from the vapor during condensing.

Here, a thermal buffer body as optimal as possible can be realized when the thermal buffering mass of the thermal buffer body is adjusted so as to be able to absorb the condensation heat of a predetermined quantity of vapor within a short time and the heat-exchanging surface of the thermal buffer body is adjusted so as to be able to absorb the condensation heat of a predetermined quantity of vapor within a short time, as has already been elucidated hereinabove.

In order to be able to design the thermal buffer body to be as compact as possible, according to the invention, it is proposed that the thermal buffer body be assembled from at least one package of metal plate-shaped bodies, which are arranged mutually parallel in an orderly configuration, while flow channels have been formed between the plate-shaped bodies. By thus designing the thermal buffer body, in a relatively small space, a condensation surface with a considerable size can be realized. This is also because the interspaces between the plate-shaped bodies can be relatively small, because, compared to, for instance, a thermal buffer body consisting of randomly poured ceramic bodies, a relatively small pressure drop occurs over the thermal buffer body, while sufficient turbulence for a good heat transfer is present.

Moreover, for the same reasons, it is possible to accommodate sufficient steel mass in the relatively small space to provide sufficient thermal buffer capacity. A further advantage of using such a thermal buffer body is that upon partial drying up of the thermal buffer body, as a result of the good heat-conductivity of the plate-shaped bodies, in contrast to ceramic bodies, the continuous and uniform heat emission proceeds virtually undisturbed.

Further, it is characteristic of such a design of the thermal buffer body that the thermodynamic properties of the condenser, being condensation surface, mass of condensation material, flow surface and flow losses, can be selected independently of one another on the basis of vapor flow rate and mass of vapor.

The flow between the plate-shaped bodies can be influenced in any desired manner by the design and mutual arrangement of the plate-shaped bodies. For instance, all plate-shaped bodies can have a flat design and be arranged at an inclination relative to a vertical plane. Of course, instead of a flat design of the plate-shaped bodies, any other suitable configuration may also be chosen. According to a further embodiment of the invention, it is preferred that the plate-shaped bodies of a package be arranged substantially vertically, with, of each plate-shaped body, a same part being bent over a bending line extending horizontally, over a same bending angle from the vertical plane. By the bent parts, the heat transfer and the coolant distribution can be influenced, while the vertical parts, by means of rods and spacer rings, enable a rapid and simple, yet accurate mutual mounting of the plate-shaped bodies. The parts of the plate-shaped bodies bent from the vertical plane are closer to one another than the vertically extending parts. Thus, by the bending angle, the flow pattern can be influenced, for instance such that a homogeneous vapor velocity distribution is achieved.

A further advantage of the parts extending at an inclination relative to the vertical is that the bottom sides of these parts will mainly be dry, which optimizes the condensation (drop condensation), while the top sides are properly wetted by coolant and can thus optimally transfer thermal energy to the coolant. This advantageous effect partly results from the use of a well heat-conducting material for the plate-shaped bodies.

A further improvement of the action of the thermal buffer body is possible if, according to a further embodiment of the invention, the thermal buffer body comprises at least two packages of plate-shaped bodies, with the vertically extending parts of a package extending perpendicular to the vertically extending parts of an adjoining package. This can improve inter alia the homogeneity of the water distribution.

As has already been mentioned, such a device may become polluted, for instance by peeling residues when used in a steam peeling process. The orderly plate-shaped design and possible homogeneous coolant distribution already considerably reduce the danger of pollution. Should there still be a need to periodically clean the device, this is possible in a simple manner as a result of the construction, when each package of plate-shaped bodies has been mounted in the housing in a dismountable manner.

As mentioned, the plate-shaped bodies may have many shapes. In this context, it is preferred that all plate-shaped bodies of a package consist of a plate which is elongated and rectangular, at least in its original shape, with, more in particular, all plates in a package being mutually identical.

During the cooling period of the device, it is, for reasons elucidated hereinabove, preferred that no environmental air be sucked into the housing of the device. This can be realized in a relatively simple manner, when the gas discharge is provided with a non-return valve. Should it, for reasons mentioned, be preferred to operate the device under underpressure, this can simply be realized by providing the gas discharge with a suction pump.

The method and device for condensing periodically released quantities of vapor will now be further elucidated with reference to exemplary embodiments shown, but only by way of non-limiting example, in the drawing, in which:

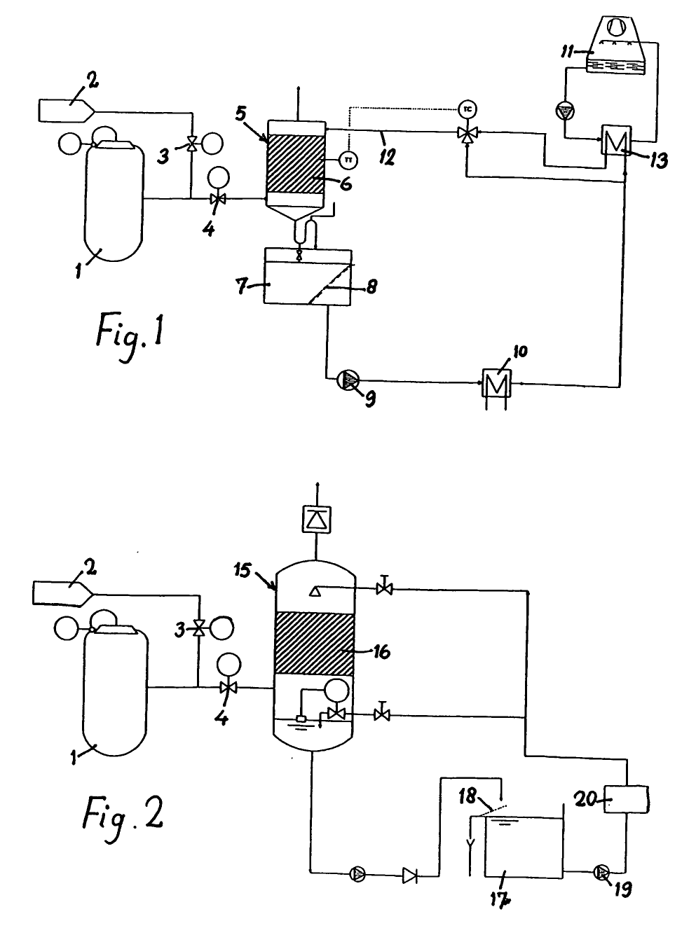

FIG. 1 shows a diagram of a steam peeling process with steam processing under atmospheric pressure;

FIG. 2 shows a diagram of a steam peeling process with steam processing under underpressure;

FIG. 3 shows, in perspective, a thermal buffer body; and

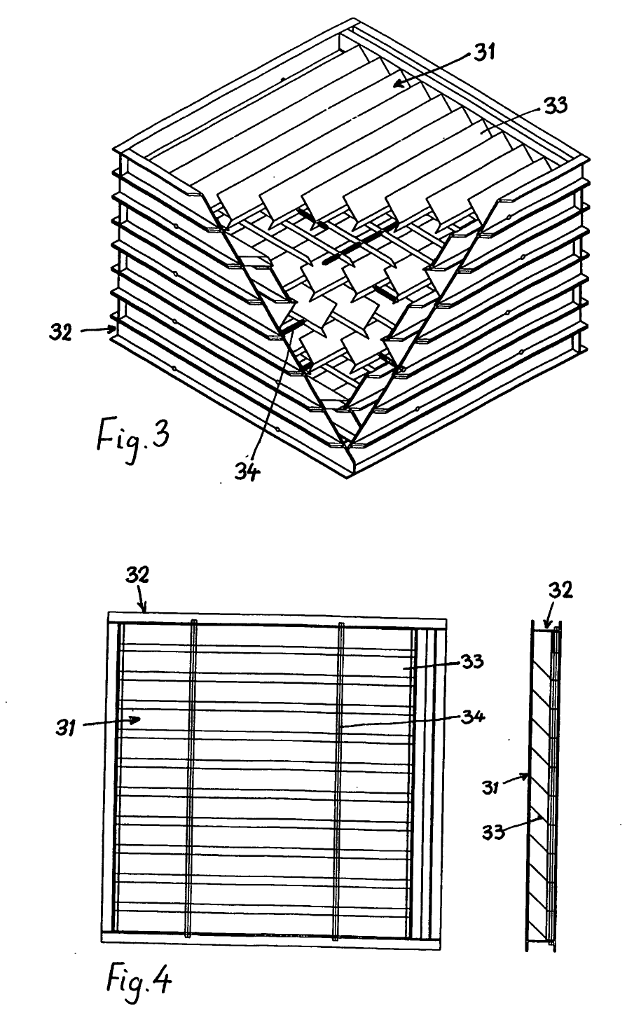

FIG. 4 shows, in top plan view and cross section, the thermal buffer body shown in FIG. 3.

FIG. 1 diagrammatically shows a steam peeling vessel 1, in which products to be peeled, such as potatoes, can be accommodated, after which, from a steam source 2, by opening a steam valve 3, steam is supplied under pressure to the closed steam peeling vessel 1. For a certain time, the steaming time, the products to be peeled are maintained under pressure, for instance 16 bars. During the steaming time, a heated water fraction penetrates into and directly under the skin of the product to be peeled. By subsequently blowing off the steam via the blow-off valve 4 within a short time and thus rapidly reducing the pressure in the vessel, partly because of the relatively high process temperature, higher than 100° C., the water fraction included in the product will explosively evaporate and thus loosen the skin from the product.

In this process, thus, a large quantity of steam is periodically and momentarily blown off. For processing thereof, the steam is supplied to a condenser 5 provided with a thermal buffer body 6, which will be further elucidated below with reference to FIGS. 3 and 4. In the condenser 5, the steam is condensed by means of water supplied via a pipe 12 and sprinkled above the thermal buffer body 6 in the condenser 5 by a combined action of the heating up of the sprinkling water and the thermal buffer body 6. By a proper dimensioning of the thermal buffer body 6 and proper choice of the quantity and temperature of the sprinkling water supplied, it can be ensured that always, i.e. both during the supply of the quantities of steam to be condensed and during the periods when no steam is supplied, at the top side of the thermal buffer body 6, a temperature prevails which is substantially equal to that of the sprinkling water supplied, while the temperature at the bottom side of the thermal buffer body 6 is always substantially equal to the condensation temperature of the steam supplied. In this manner, at the bottom side of the condenser 5, water having a virtually constant and relatively high temperature can continuously be discharged to a buffer vessel 7 with a sieve 8 for collecting the peels loosened from the product and carried along with the steam from the steam peeling vessel 1.

The temperature of the water in the buffer vessel 7 has such a high value that a reutilization of the thermal energy is possible in an effective and profitable manner. For this purpose, the water is abstracted from the buffer vessel 7 via a pump 9 and supplied to residual heat consumers 10 shown diagrammatically, after which the water with a then reduced temperature can again, via the pipe 12, be supplied as sprinkling water to the condenser 5, optionally after being led through a heat exchanger 13 connected to an auxiliary or emergency cooler 11.

Non-condensable gases are discharged at the top side of the condenser. This can take place via an open connection with the atmosphere. During the cooling periods of the thermal buffer body 6, such a design of the condenser 5 will allow air from the environment to be sucked into the condenser via the open connection. If it is desired to prevent this, this can be realized by closing off the open connection by a non-return valve, so that, with underpressure in the condenser, the connection to the environment remains closed.

One step further, the process can always be carried out under underpressure. Such a process is diagrammatically shown in FIG. 2. Here, the steam blow-off valve 4 connects to a condenser 15 in the form of a closed vessel to which, instead of the non-return valve mentioned in the previous paragraph, a vacuum pump 21 is connected. Water sprinkled above the thermal buffer body 16 is, after heating up, discharged to a buffer vessel 17 with sieve 18 and supplied via a pump 19 to residual heat consumers 20, and then returned to the condenser 15.

FIG. 3 shows, in perspective, one of the many possible embodiments of the thermal buffer body 6 or 16, albeit an embodiment which is preferred. The thermal buffer body is built up from a number of plate assemblies 31, which are included in a frame 32. Each frame 32 is assembled from a number of U-sections and carries a large number of plate-shaped elements 33, which are mounted in the frame 32 by means of rods 34, on which spacer sleeves have been slid between each two plate-shaped elements 33 in order to mutually fix them in a parallel position. Each plate-shaped element 33 is provided with a part extending vertically and a bent part connected thereto. It is noted that, in practice, the mutual distance between two adjoining plate-shaped elements 33 will be considerably smaller than has been drawn in the Figures for reasons of clarity. Further, with respect to the direction in which the plate-shaped elements 33 extend in the horizontal direction, each plate assembly 31 has been rotated a quarter turn relative to an adjoining plate assembly 31.

In this manner, a thermal buffer body can be formed which can be dimensioned as needed, which body, as a result of its modular form, can be simply and, if desired, partly dismounted for the purpose of cleaning, maintenance and repair, while it also remains possible to afterwards adjust the thermal buffering capacity to a changed need.

It is obvious that, within the scope of the invention as set forth in the appended claims, many modifications and variants are possible. For instance, the embodiment shown of the thermal buffer body is, as mentioned, only one of many possible embodiments. Other possibilities are, for instance, non-bent, straight plates, which are arranged in the frames, optionally at an inclination. Instead of a large number of rather flat frames, one or a smaller number of higher frames are also possible, in which, then, for instance, plate-shaped elements with a higher design may be accommodated which are, optionally, each bent a number of times. Instead of by rods, the plate-shaped elements may also be mutually locked in another manner, for instance by provisions at the ends of the plate-shaped elements.

1. A method for condensing periodically and momentarily released large quantities of vapor, such as water vapor, with condensable and non-condensable gaseous components by condensing the condensable components of the vapor in an enclosed space by means of a cooling fluid, such as water, after which the heated cooling fluid and condensed components are together discharged from the enclosed space via a fluid discharge pipe, characterized in that the vapor is led through and along a thermal buffer body having a relatively large thermal buffering mass and heat-exchanging surface, which is vertically arranged in the enclosed space, so that the periodically and momentarily released large quantities of vapor supplied from the bottom up are condensed while, simultaneously, periodically heating up the thermal buffer body, which is continuously cooled by coolant supplied from above and flowing or dripping down.

2. A method according to claim 1, characterized in that the thermal buffering mass of the thermal buffer body is adjusted so as to be able to absorb the condensation heat of a predetermined quantity of vapor within a short time.

3. A method according to claim 1, characterized in that the heat exchanging surface of the thermal buffer body is adjusted so as to be able to absorb the condensation heat of a predetermined quantity of vapor within a short time.

4. A method according to claim 1, characterized in that the vapor flowing through and along the thermal buffer body is led through a plurality of channels substantially identical in shape which are arranged in the thermal buffer body in an orderly manner.

5. A method according to claim 4, characterized in that the rising vapor in the channels is subjected to at least one deflection in the flow direction.

6. A method according to claim 1, characterized in that the non-condensable elements are discharged via the discharge pipe only when an overpressure prevails in the enclosed space in relation to a space to which the non-condensable elements are discharged.

7. A method according to claim 1, characterized in that an underpressure is generated in the enclosed space.

8. A device for condensing periodically and momentarily released large quantities of vapor, such as water vapor, with condensable and non-condensable gaseous components, which device is provided with a housing which forms an enclosed space and is provided with a steam supply, a fluid discharge, a gas discharge and a coolant supply, characterize din that, in the enclosed space, a compacted thermal buffer body extending in the vertical direction and provided with a plurality of passages is arranged which has a relatively large thermal buffering mass and heat-exchanging surface, wherein the steam supply and the fluid discharge are located vertically below the thermal buffer body and the gas discharge and coolant supply are located vertically above the thermal buffer body.

9. A device according to claim 8, characterized in that the thermal buffering mass of the thermal buffer body is adjusted so as to be able to absorb the condensation heat of a predetermined quantity of vapor within a short time.

10. A device according to claim 8, characterized in that the heat-exchanging surface of the thermal buffer body is adjusted so as to be able to absorb the condensation heat of a predetermined quantity of vapor within a short time.

11. A device according to claim 8, characterized in that the thermal buffer body is assembled from at least one package of metal plate-shaped bodies, which are arranged mutually parallel in an orderly configuration, wherein flow channels have been formed between the plate-shaped bodies.

12. A device according to claim 11, characterized in that the plate-shaped bodies of a package are arranged substantially vertically, wherein, of each plate-shaped body, a same part has been bent over a bending line extending horizontally, over a same bending angle from the vertical plane.

13. A device according to claim 11, characterized in that the thermal buffer body comprises at least two packages of plate-shaped bodies, wherein the vertically extending parts of a package extend perpendicular to the vertically extending parts of an adjoining package.

14. A device according to claim 11, characterized in that each package of plate-shaped bodies has been mounted in the housing in a dismountable manner.

15. A device according to claim 14, characterized in that each package of plate-shaped bodies has been mounted in a frame which has been mounted in the housing in a dismountable manner.

16. A device according to claim 11, characterized in that all plates in a package are mutually identical.

17. A device according to claim 11, characterized in that all plate-shaped bodies of a package consist of a plate which is elongated and rectangular, at least in its original shape.

18. A device according to claim 8, characterized in that the gas discharge is provided with a non-return valve.

19. A device according to claim 8, characterized in that the gas discharge is provided with a suction pump.
